(19) United States
(12) Patent Application Publication
(10) Pub. No.: US 2004/0029944 A1
(43) Pub. Date: Feb. 12, 2004

(54) Fungicide mixtures

(76) Inventors: Thomas Grote, Wachenheim (DE); Arne Ptock, Ludwigshafen (DE); Eberhard Ammermann, Heppenheim (DE); Reinhard Stierl, Mutterstadt (DE); Gisela Lorenz, Hambach (DE); Siegfried Strathmann, Limburgerhof (DE); Maria Scherer, Landau (DE); Klaus Schelberger, Gonnheim (DE); Egon Haden, Kleinniedesheim (DE)

Correspondence Address: KEIL & WEINKAUF, 1350 CONNECTICUT AVENUE, N.W., WASHINGTON, DC, 20036, US

(21) Appl. No.: 10/250,565

(22) PCT Filed: Jan. 12, 2002
(86) PCT No.: PCT/EP02/00237

(30) Foreign Application Priority Data
Jan. 16, 2001 (DE) 101 01 921.1

(51) Int. Cl. A01N 43/50; A01N 37/28

(52) U.S. Cl. 514/397; 514/398; 514/575

(57) ABSTRACT

Fungicidal mixtures, comprising

A) imidazole derivatives of the formula I

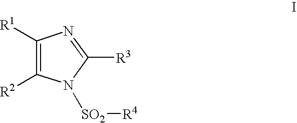

in which R¹ and R² are halogen or phenyl which may be substituted by halogen or alkyl, or R¹ and R² together with the bridging C═C double bond form a 3,4-difluoromethylenedioxyphenyl group; R³ is cyano or halogen, and R⁴ is di(C₁-C₄-alkyl)amino or isoxazol-4-yl which may carry two C₁-C₄-alkyl radicals; and

B) at least one phenylacetic acid derivative II selected from the group of the formulae IIa to IIe:

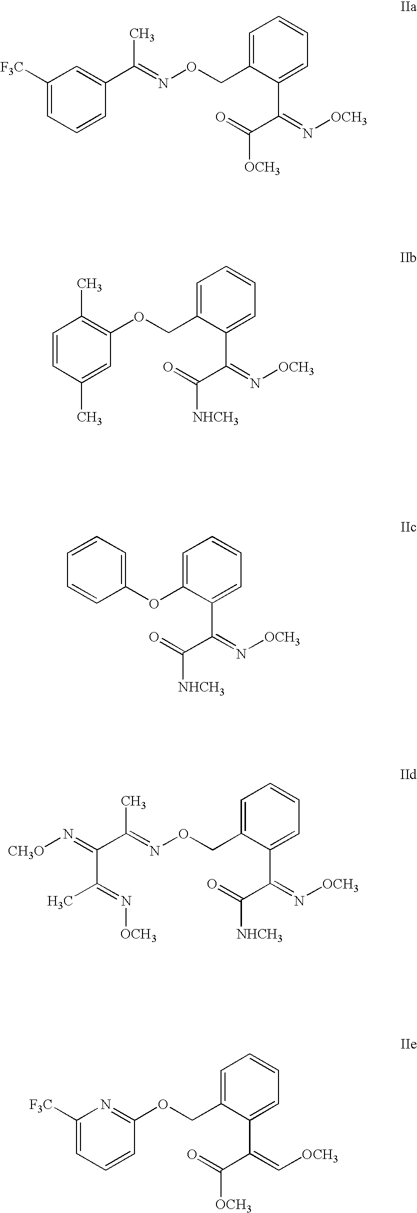

in a synergistically effective amount, processes for controlling harmful fungi using mixtures of the compounds I and II (IIa to IIe) and compositions comprising them are described.

The present invention relates to fungicidal mixtures, comprising

A) imidazole derivatives of the formula I

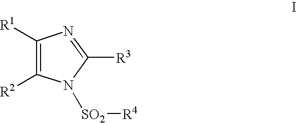

in which R¹ and R² are halogen or phenyl which may be substituted by halogen or C₁-C₄-alkyl, or

R¹ and R² together with the bridging C═C double bond form a 3,4-difluoromethylenedioxyphenyl group;

R³ is cyano or halogen, and

R⁴ is di(C₁-C₄-alkyl)amino or isoxazol-4-yl which may carry two C₁-C₄-alkyl radicals; and

B) at least one phenylacetic acid derivative II selected from the group of the formulae IIa to IIe:

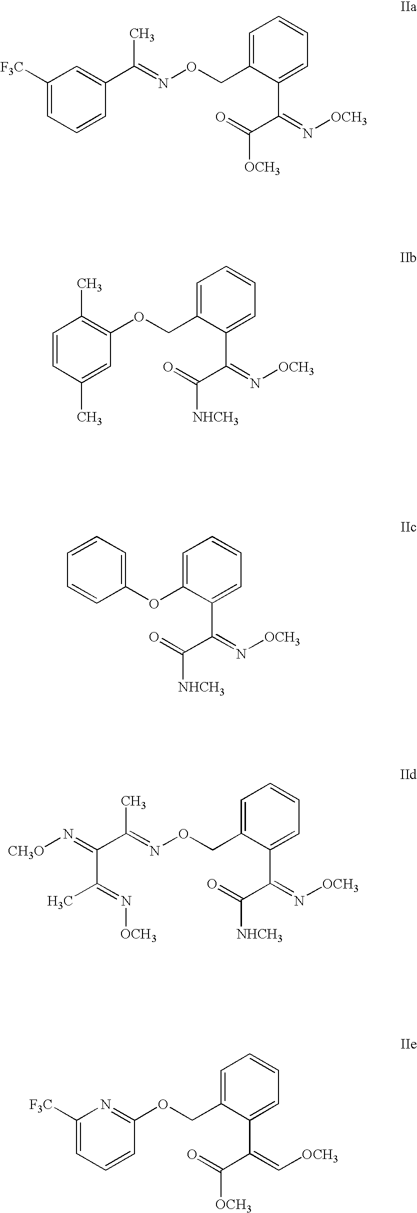

in a synergistically effective amount.

Moreover, the invention relates to processes for controlling harmful fungi using mixtures of the compounds I and II (IIa to IIe) and to the use of the compounds I and the compounds II for preparing such mixtures.

The imidazole derivatives of the formula I, their preparation and their action against harmful fungi are known from the literature (EP-A 298 196, WO-A 97/06171).

Also known are the phenylacetic acid derivatives of the formula II (IIa to IIe), their preparation and their action against harmful fungi (EP-A 278 595, EP-A 398 692, EP-A 460 575, WO 97/15552).

It is an object of the present invention to provide mixtures which have an improved activity against harmful fungi combined with a reduced total amount of active compound applied (synergistic mixtures), with a view to reducing the application rates and improving the activity spectrum of the known compounds I and II.

We have found that this object is achieved by the mixture defined at the outset. Moreover, we have found that applying the compounds I and II simultaneously, i.e. together or separately, or applying the compounds I and the compounds II in succession provides better control of harmful fungi than is possible with the individual compounds alone.

The formula I represents in particular imidazole derivatives of the formula I in which R¹ is halogen, in particular chlorine, and R² is tolyl, in particular p-tolyl.

Preference is likewise given to compounds of the formula I in which R⁴ is dimethylamino.

In addition, particular preference is given to the compound of the formula Ia (common name: cyazofamid). This compound is known from EP-A 298 196.

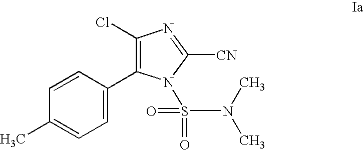

Furthermore preferred are compounds of the formula I in which R¹ and R² together with the bridging C═C double bond form a 3,4-difluoromethylenedioxyphenyl group.

In addition, preference is given to compounds of the formula I in which R⁴ is 3,5-dimethylisoxazol-4-yl.

Particular preference is given to the compounds of the formula Ib in which X is halogen.

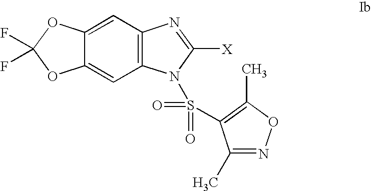

Halogen denotes fluorine, chlorine, bromine and iodine. Particular preference is given to compounds of the formula Ib in which X is bromine (Ib.1) or chlorine (Ib.2).

Preference is given to two-component mixtures comprising one imidazole derivative I and one phenylacetic acid derivative II.

Particular preference is given to the mixtures of compound Ia with a phenylacetic acid derivative from the group of the formulae IIa to IIe.

Owing to the basic character of their nitrogen atoms, the compounds I and II are capable of forming salts or adducts with inorganic or organic acids or with metal ions.

Examples of inorganic acids are hydrohalic acids, such as hydrogen fluoride, hydrogen chloride, hydrogen bromide and hydrogen iodide, carbonic acid, sulfuric acid, phosphoric acid and nitric acid.

Suitable organic acids are, for example, formic acid and alkanoic acids, such as acetic acid, trifluoroacetic acid, trichloroacetic acid and propionic acid, and also glycolic acid, lactic acid, succinic acid, citric acid, benzoic acid, cinnamic acid, oxalic acid, p-toluenesulfonic acid, salicylic acid, p-aminosalicylic acid, 2-phenoxybenzoic acid and 2-acetoxybenzoic acid.

Suitable metal ions are, in particular, the ions of the elements chromium, manganese, iron, cobalt, nickel, copper, zinc, calcium, magnesium, aluminum, tin and lead. If appropriate, the metals can be present in the various valencies that they can assume.

When preparing the mixtures, it is preferred to employ the pure active ingredients I and II (IIa to IIe), to which further active ingredients against harmful fungi or other pests, such as insects, arachnids or nematodes, or else herbicidal or growth-regulating active ingredients or fertilizers can be admixed.

The mixtures of the compounds I and II, or the compounds I and II used simultaneously, jointly or separately, exhibit outstanding activity against a wide range of phytopathogenic fungi, in particular from the classes of the Ascomycetes, Basidiomycetes, Phycomycetes and Deuteromycetes. Some of them act systemically and can therefore be employed also as foliar- and soil-acting fungicides.

They are especially important for controlling a large number of fungi in a variety of crop plants, such as cotton, vegetable species (e.g. cucumbers, beans, tomatoes, potatoes and cucurbits), barley, grass, oats, bananas, coffee, maize, fruit species, rice, rye, soya, grapevine, wheat, ornamentals, sugar cane, and a variety of seeds.

They are particularly suitable for controlling the following phytopathogenic fungi: Erysiphe graminis (powdery mildew) in cereals, Erysiphe cichoracearum and Sphaerotheca fuliginea in cucurbits, Podosphaera leucotricha in apples, Uncinula necator in grapevines, Puccinia species in cereals, Rhizoctonia species in cotton, rice and lawns, Ustilago species in cereals and sugar cane, Venturia inaequalis (scab) in apples, Helminthosporium species in cereals, Septoria nodorum in wheat, Botrytis cinera (gray mold) in strawberries, vegetables, ornamentals and grapevines, Cercospora arachidicola in groundnuts, Pseudocercosporella herpotrichoides in wheat and barley, Pyricularia oryzae in rice, Phytophthora infestans in potatoes and tomatoes, Plasmopara viticola in grapevines, Pseudoperonospora speci s in hops and cucumbers, Alternaria species in vegetables and fruit, Mycosphaerella species in bananas and Fusarium and Verticillium species.

They can furthermore be employed in the protection of materials (for example the protection of wood), for example against Paecilomyces variotii.

The compounds I and II can be applied simultaneously, that is either together or separately, or successively, the sequence, in the case of separate application, generally not having any effect on the result of the control measures.

The compounds I and II are usually employed in a weight ratio of from 20:1 to 1:20, in particular from 10:1 to 1:10, preferably from 5:1 to 1:5.

Depending on the kind of effect desired, the application rates of the mixtures according to the invention are, in particular in agricultural crop areas, from 0.01 to 8 kg/ha, preferably 0.1 to 5 kg/ha, in particular 0.1 to 3.0 kg/ha.

The application rates of the compounds I are from 0.01 to 1 kg/ha, preferably 0.05 to 0.5 kg/ha, in particular 0.05 to 0.3 kg/ha.

Correspondingly, in the case of the compounds II, the application rates are from 0.01 to 1 kg/ha, preferably 0.02 to 0.5 kg/ha, in particular 0.05 to 0.3 kg/ha.

For seed treatment, the application rates of the mixture are generally from 0.001 to 250 g/kg of seed, preferably 0.01 to 100 g/kg, in particular 0.01 to 50 g/kg.

If phytopathogenic harmful fungi are to be controlled, the separate or joint application of the compounds I and II or of the mixtures of the compounds I and II is effected by spraying or dusting the seeds, the plants or the soils before or after sowing of the plants, or before or after plant emergence.

The fungicidal synergistic mixtures according to the invention or the compounds I and II can be formulated for example in the form of ready-to-spray solutions, powders and suspensions or in the form of highly concentrated aqueous, oily or other suspensions, dispersions, emulsions, oil dispersions, pastes, dusts, materials for broadcasting or granules, and applied by spraying, atomizing, dusting, broadcasting or watering. The use form depends on the intended purpose; in any case, it should ensure as fine and uniform as possible a distribution of the mixture according to the invention.

The formulations are prepared in a known manner, e.g. by adding solvents and/or carriers. The formulations are usually admixed with inert additives, such as emulsifiers and dispersants.

Suitable surfactants are the alkali metal salts, alkaline earth metal salts and ammonium salts of aromatic sulfonic acids, e.g. ligno-, phenol-, naphthalene- and dibutylnaphthalenesulfonic acid, and of fatty acids, alkyl- and alkylarylsulfonates, alkyl, lauryl ether and fatty alcohol sulfates, and salts of sulfated hexa-, hepta- and octadecanols, or of fatty alcohol glycol ethers, condensates of sulfonated naphthalene and its derivatives with formaldehyde, condensates of naphthalene or of the naphthalenesulfonic acids with phenol and formaldehyde, polyoxyethylene octylphenol ether, ethoxylated isooctyl-, octyl- or nonylphenol, alkylphenyl or tributylphenyl polyglycol ethers, alkylaryl polyether alcohols, isotridecyl alcohol, fatty alcohol/ethylene oxide condensates, ethoxylated castor oil, polyoxyethylene alkyl ethers or polyoxypropylene alkyl ethers, lauryl alcohol polyglycol ether acetate, sorbitol esters, lignosulfite waste liquors or methylcellulose.

Powders, materials for broadcasting and dusts can be prepared by mixing or jointly grinding the compounds I or II or the mixture of the compounds I and II with a solid carrier.

Granules (e.g. coated granules, impregnated granules or homogeneous granules) are usually prepared by binding the active compound, or active compounds, to a solid carrier.

Fillers or solid carriers are, for example, mineral earths, such as silicas, silica gels, silicates, talc, kaolin, limestone, lime, chalk, bole, loess, clay, dolomite, diatomaceous earth, calcium sulfate, magnesium sulfate, magnesium oxide, ground synthetic materials and fertilizers, such as ammonium sulfate, ammonium phosphate, ammonium nitrate, ureas, and products of vegetable origin, such as cereal meal, tree bark meal, wood meal and nutshell meal, cellulose powders or other solid carriers. The formulations generally comprise from 0.1 to 95% by weight, preferably 0.5 to 90% by weight, of one of the compounds I and II or of the mixture of the compounds I and II. The active compounds are employed in a purity of from 90% to 100%, preferably 95% to 100% (according to NMR spectrum or HPLC).

The compounds I and II, the mixtures, or the corresponding formulations, are applied by treating the harmful fungi, their habitat, or the plants, seeds, soils, areas, materials or spaces to be kept free from them with a fungicidally effective amount of the mixture, or of the compounds I and II in the case of separate application.

Application can be effected before or after infection by the harmful fungi.

### USE EXAMPLES

The synergistic activity of the mixtures according to the invention was demonstrated by the following experiments:

The active compounds, separately or together, were formulated as a 10% emulsion in a mixture of 63% by weight of cyclohexanone and 27% by weight of emulsifier, and diluted with water to the desired concentration.

Evaluation was carried out by determining the infected leaf areas in percent. These percentages were converted into efficacies. The efficacy (W) was calculated as follows using Abbot's formula:

W=(1−α)·100/β

α corresponds to the fungal infection of the treated plants in % and

β corresponds to the fungal infection of the untreated (control) plants in %

An efficacy of 0 means that the infection level of the treated plants corresponds to that of the untreated control plants; an efficacy of 100 means that the treated plants were not infected. The expected efficacies of the mixtures of the active compounds were determin d using Colby's formula [R. S. Colby, Weeds 15, 20-22 (1967)] and compared with the observed efficacies.

Colby's formula: E=x+y−x·y/100

E expected efficacy, expressed in % of the untreated control, when using the mixture of the active compounds A and B at the concentrations a and b

x efficacy, expressed in % of the untreated control, when using active compound A at a concentration a

y efficacy, expressed in % of the untreated control, when using active compound B at a concentration b.

### USE EXAMPLE

### Protective Activity Against Tomato Blight Caused by Phytophthora infestans

Leaves of potted plants of the cultivar “Groβe Fleischtomate St. Pierre” were sprayed to runoff point with an aqueous suspension which had been prepared from a stock solution comprising 10% of active compound, 85% of cyclohexanone and 5% of emulsifier. The next day, the leaves were infected with a cold aqueous zoospore suspension of Phytophthora infestans of a concentration of 0.25×10⁶ spores/ml. The plants were then placed in a water-vapor-saturated chamber at 18-20° C. After 6 days, the tomato blight on the untreated, but infected control plants had developed to such an extent that the infection could be determined visually in %.

TABLE A
Individual active compounds

| | | Concentration of | |
|---|---|---|---|
| | | active compound | Efficacy in % of |
| | | in the spray | the untreated |
| Example | Active compound | liquor [ppm] | control |
| 1 | control | (95% infection) | 0 |
| | (untreated) | | |
| 2 | cyazofamid | 0.2 | 84 |
| | Ia | 0.1 | 74 |
| | | 0.05 | 58 |
| 3 | Ib.1 | 0.2 | 87 |
| | | 0.1 | 73 |
| | | 0.05 | 47 |
| 4 | IIa | 2 | 58 |
| | | 1 | 58 |
| | | 0.5 | 5 |
| 5 | IIb | 0.1 | 74 |
| | | 0.05 | 47 |
| 6 | IId | 2 | 68 |
| | | 1 | 58 |
| | | 0.5 | 37 |

TABLE B
Combinations according to the invention

| | Active compound | | |
|---|---|---|---|
| | mixture | | |
| | concentration mixing | Observed | Calculated |
| Example | ratio | efficacy | efficacy* |
| 7 | Ia + IIa | 100 | 89 |
| | 0.05 + 0.5 ppm | | |
| | 1:10 | | |
| 8 | Ia + IIa | 100 | 75 |
| | 0.1 + 0.5 ppm | | |
| | 1:5 | | |
| 9 | Ia + IIa | 100 | 85 |
| | 0.2 + 0.5 ppm | | |
| | 1:2.5 | | |
| 10 | Ia + IIa | 100 | 82 |
| | 0.05 + 1 ppm | | |
| | 1:20 | | |
| 11 | Ia + IIa | 100 | 82 |
| | 0.05 + 2 ppm | | |
| | 1:40 | | |
| 12 | Ib.1 + IIa | 100 | 89 |
| | 0.05 + 0.5 ppm | | |
| | 1:10 | | |
| 13 | Ib.1 + IIa | 100 | 74 |
| | 0.1 + 0.5 ppm | | |
| | 1:5 | | |
| 14 | Ib.1 + IIa | 100 | 88 |
| | 0.2 + 0.5 ppm | | |
| | 1:2.5 | | |
| 15 | Ib.1 + IIa | 100 | 78 |
| | 0.05 + 1 ppm | | |
| | 1:20 | | |
| 16 | Ib.1 + IIa | 100 | 78 |
| | 0.05 + 2 ppm | | |
| | 1:40 | | |
| 17 | Ia + IIb | 100 | 86 |
| | 0.1 + 0.05 ppm | | |
| | 2:1 | | |
| 18 | Ia + IIb | 100 | 89 |
| | 0.05 + 0.1 ppm | | |
| | 1:2 | | |
| 19 | Ia + IIb | 100 | 86 |
| | 0.1 + 0.05 ppm | | |
| | 2:1 | | |
| 20 | Ib.1 + IIb | 97 | 86 |
| | 0.05 + 0.1 ppm | | |
| | 1:2 | | |
| 21 | Ia + IId | 100 | 89 |
| | 0.05 + 0.5 ppm | | |
| | 1:10 | | |
| 22 | Ia + IId | 100 | 83 |
| | 0.1 + 0.5 ppm | | |
| | 1:5 | | |
| 23 | Ia + IId | 100 | 82 |
| | 0.05 + 1 ppm | | |
| | 1:20 | | |
| 24 | Ia + IId | 100 | 87 |
| | 0.05 + 2 ppm | | |
| | 1:40 | | |
| 25 | Ib.1 + IId | 100 | 89 |
| | 0.05 + 0.5 ppm | | |
| | 1:10 | | |
| 26 | Ib.1 + IId | 100 | 83 |
| | 0.1 + 0.5 ppm | | |
| | 1:5 | | |
| 27 | Ib.1 + IId | 100 | 78 |
| | 0.05 + 1 ppm | | |
| | 1:20 | | |
| 28 | Ib.1 + IId | 100 | 83 |
| | 0.05 + 2 ppm | | |
| | 1:40 | | |

*calculated using Colby's formula

The test results show that for all mixing ratios the observed efficacy is higher than the efficacy which had been calculated beforehand using Colby's formula.

1. (original) A fungicidal mixture, comprising
A) imidazole derivatives of the formula I 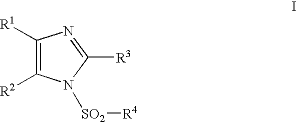
in which R¹ and R² are halogen or phenyl which may be substituted by halogen or C₁-C₄-alkyl, or
R¹ and R² together with the bridging C═C double bond form a 3,4-difluoromethylenedioxyphenyl group;
R³ is cyano or halogen, and
R⁴ is di(C₁-C₄-alkyl)amino or isoxazol-4-yl which may carry two C₁-C₄-alkyl radicals; and
B) at least one phenylacetic acid derivative II selected from the group of the formulae IIa to IIe: 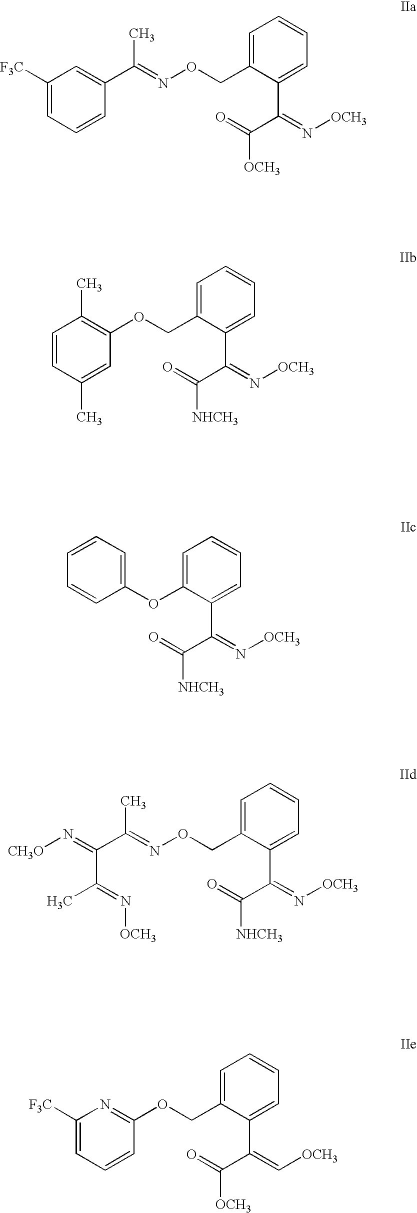
in a synergistically effective amount.

2. (original) A fungicidal mixture as claimed in claim 1, where the imidazole derivative I corresponds to the formula Ia.

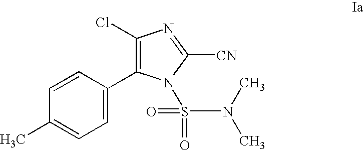

3. (original) A fungicidal mixture as claimed in claim 1, where the imidazole derivative I corresponds to the formula Ib 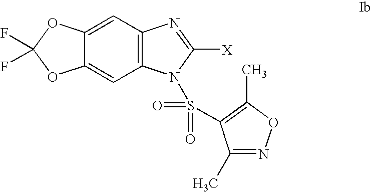
where X is chlorine or bromine.

4. (currently amended) A fungicidal mixture as claimed in claim 1 any claims 1 to 3, wherein the weight ratio of the imidazole derivatives I to the phenylacetic acid derivative of the formula II is from 20:1 to 1:20.

5. (original) A method for controlling harmful fungi, which comprises treating the fungi, their habitat or the plants, seeds, soils, areas, materials or spaces to be kept free from them with imidazole derivatives of the formula I as set forth in claim 1 and phenylacetic acid derivatives of the formula II as set forth in claim 1.

6. (currently amended ) A method as claimed in claim 5, wherein the imidazole derivatives of the formula I as set forth in claim 1 and the phenylacetic acid derivatives of the formula II as set forth in claim 1 are applied simultaneously, that is either together or separately, or successively.

7. (currently amended) A method as claimed in claim 5 or 6, wherein the imidazole derivatives of the formula I as set forth in claim 1 are applied in an amount of from 0.01 to 2.5 kg/ha.

8. (currently amended) A method as claimed in claim 5 any of claims 5 to 7, wherein the phenylacetic acid derivatives of the formula II as set forth in claim 1 are applied in an amount of from 0.01 to 10 kg/ha.

9. (original) A fungicidal mixture, which is conditioned in two parts, where one part comprises imidazole derivatives of the formula I as set forth in claim 1 in a solid or liquid carrier and the other part comprises phenylacetic acid derivatives of the formula II as set forth in claim 1 in a solid or liquid carrier.
